(19) United States
(12) Patent Application Publication
(10) Pub. No.: US 2010/0068597 A1
(43) Pub. Date: Mar. 18, 2010

(54) HOUSING FOR RECEIVING AND TENSIONING AT LEAST ONE FUEL CELL STACK

(75) Inventors: Jens Hafemeister, Neustrelitz (DE); Matthias Boltze, Wulkenzin (Ot Neuendorf) (DE)

Correspondence Address: FITCH EVEN TABIN & FLANNERY, 120 SOUTH LASALLE STREET, SUITE 1600, CHICAGO, IL, 60603-3406, US

(73) Assignee: Enerday GmbH, Neubrandenburg (DE)

(21) Appl. No.: 12/516,545

(22) PCT Filed: Oct. 29, 2007
(86) PCT No.: PCT/DE07/01943

§ 371 Date: May 27, 2009

(30) Foreign Application Priority Data
Dec. 21, 2006 (DE) 10 2006 060 810.0

(51) Int. Cl. H01M 2/02

(52) U.S. Cl. 429/34

(57) ABSTRACT

The invention relates to a housing for accommodating at least one fuel cell stack comprising a housing part formed so that it is capable of at least partly accommodating the fuel cell stack. According to the invention it is envisaged that clamping means are provided by which the fuel cell stack is restrainable via at least one orifice of the housing portion. The invention further relates to a system comprising such a housing and at least one fuel cell stack accommodated therein.

The invention relates to a housing for accommodating at least one fuel cell stack comprising a housing portion formed so that it is capable of at least partly accommodating the fuel cell stack.

The invention further relates to a system comprising such a housing and at least one fuel cell stack accommodated therein.

Fuel cell systems, particularly SOFC fuel cell systems (SOFC: “Solid Oxide Fuel Cell”) usually comprise a reformer, an afterburner, a SOFC fuel cell stack or SOFC stack, etc. With respect to the production the SOFC fuel cell stack is conventionally produced using a defined restraint. Said restraint first has to be ensured by a temporary restraint during the production and beyond it during storage and during the installation in the fuel cell system. Then a final restraint of the fuel cell stack by means of clamping means usually provided on the fuel cell stack is effected.

In the DE 195 17 042 C1, for example, a fuel cell arrangement is described in which a fuel cell stack is arranged or accommodated in a generic housing. On the fuel cell stack a terminal bellow supported on the housing and therefore capable of applying a force to the fuel cell stack for restraining the fuel cell stack is provided as a clamping means. To be capable of suitably adjusting or modifying the corresponding force a pressurised gas may be introduced into the bellow from outside of the housing.

Another possible restraint is known from the DE 103 08 382 B3. In accordance with said state of the art document the fuel cell stack is first restrained using a temporary restraining device or clamping means after cooling in the oven, then the fuel cell stack is insulated, a final restraining device or clamping means is provided outside of the insulation, and then the temporary clamping means is removed. However, particularly the perpetration of this kind of restraint has the disadvantage that the restraint does not prevent shrinking to a sufficient degree if the high temperature insulation shrinks under pressure and a high temperature. Therefore the restraint of the fuel cell stack cannot be permanently ensured. In addition said restraint can only be achieved under considerable assembly requirements so that no installation-effective solution is provided. Likewise no different restraints of the respective fuel cell stacks can be realised in case of a plurality of fuel cell stacks.

The invention is based on the object to further develop the generic housings so that the above disadvantages can, at least partly, be overcome.

Said object is solved by the features of the independent claim.

Advantageous embodiments and further developments of the invention will become apparent from the dependent claims.

The housing according to the invention is based on the generic state of the art in that clamping means are provided by means of which the fuel cell stack is restrainable via at least one orifice of the housing portion. In this context clamping means identify those components which effect the restraint of the fuel cell stack due to a transmission of forces. The housing according to the invention may, in particular, be formed as a so-called hot-box for accommodating and restraining fuel cell stacks which is thermally insulated with respect to the outside. By providing the orifice in the housing portion, for example in a part of the housing or in a plurality of housing parts, the fuel cell stack can be accurately aligned by the clamping means via the orifice so that the restraint of the fuel cell stack is readily adjustable. Likewise the alignment of the fuel cell stack or the adjustment of the restraint of the fuel cell stack may be effected via a plurality of orifices. Thus the adjustment of the restraint and therefore the installation of the fuel cell stack in the hot-box can be considerably simplified with respect to the construction whereby a relatively cost-effective solution is achieved.

The housing according to the invention may, advantageously, be further developed by providing the clamping means with a clamping body inserted into the orifice for restraining the fuel cell stack. For example, one or more cylindrical orifices may be provided on the housing portion into which, in particular, cylinders may be fitted or inserted. The cylinders may, for example, be restrained versus the corresponding fuel cell stack by a pressure plate.

Furthermore, the housing according to the invention can be realised so that the clamping body is clampable against the fuel cell stack by means of a force of at least one resilient element. Thereby a permanent restraint of the fuel cell stack can be achieved even under consideration of the shrinkage behaviour of high temperature insulations. In addition the restraint of the fuel cell stack may be exactly metered by an appropriate selection or design and positioning of the resilient element. In a case in which the housing accommodates a plurality of fuel cell stacks the restraining forces of the respective fuel cell stacks can be individually adjusted via the plurality of resilient elements used.

In this connection the housing according to the invention may preferably be formed so that the force of the at least one resilient element attached to the outer side of the housing portion is applicable to the clamping body via a pressure element. In this way the pressure element may, for example, restrain the fuel cell stack versus the housing portion due to the force applied by the resilient element.

The housing according to the invention may further be realised so that the clamping body is a ceramic cylinder.

In addition the housing according to the invention can be designed so that the resilient element comprises at least one spring. Likewise washers of screw connections may be used for providing a uniform restraint.

Furthermore the housing according to the invention may be further developed so that the pressure element is a pressure plate or a clamping frame. The pressure plate is, for example, movably screwed to the outer side of a metal shell of the housing portion, for example to housing parts of the hot-box and pre-loaded towards ceramic cylinders by means of resilient elements so that the ceramic cylinders in turn restrain the fuel cell stack. Alternatively also a restraint by means of the clamping frame is possible, which is, for example, provided on the outer side of the housing parts so that it, at least partly, surrounds the hot-box.

In this connection it is considered advantageous to provide the housing according to the invention so that a plurality of clamping bodies is tenterable against the fuel cell stack via the pressure plate. The clamping bodies may, for example, be uniformly biased towards a face of a fuel cell stack. In this way a uniform restraint of the fuel cell stack can be achieved by the uniform distribution of the clamping bodies.

The housing according to the invention can further be realised so that the housing portion is formed of a high temperature-resistant insulation material. Particularly the hot-box consists of a high temperature-resistant insulation material.

The housing according to the invention may preferably be formed so that the housing portion is surrounded by a metal shell. The insulation material used for the hot-box may be received in and protected by a metal shell.

In addition the housing according to the invention is advantageously further developed so that the fuel cell stack is restrainable versus the housing portion in its stacking direction by the clamping means.

The invention also relates to a system comprising the housing according to the invention and at least one fuel cell stack accommodated therein.

A preferred embodiment of the invention will be explained by way of example below with reference to the accompanying drawings in which:

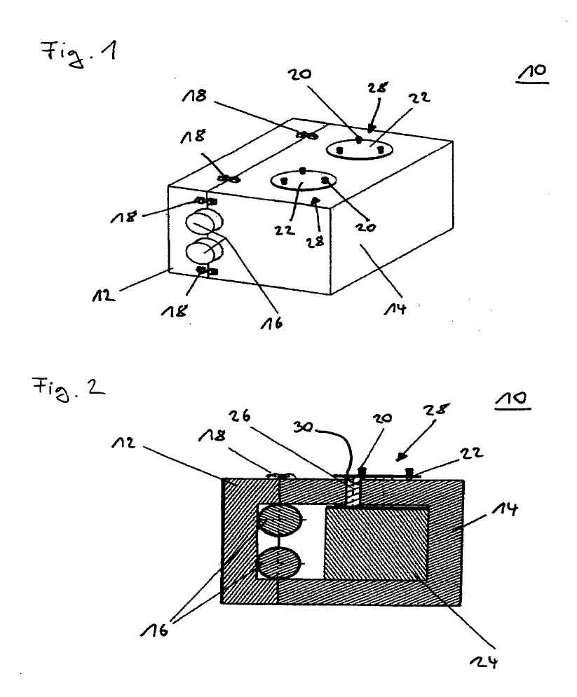

FIG. 1 is an isometric representation of the housing according to the invention, and

FIG. 2 is a cross sectional view of the housing according to the invention shown in FIG. 1.

FIGS. 1 and 2 show an isometric representation as well as a cross sectional view of a housing 10 according to the invention, respectively. In the present embodiment the housing 10 according to the invention is formed by a hot-box and comprises a housing part 14 forming a housing portion at least partially surrounding a stack of fuel cells or fuel cell stack 24. The housing part 14 is coupled with a further housing part 12 so that the fuel cell stack 24 is fully encased by the housing parts 14, 12. The coupling or housing part lock 18 of the two housing parts 14, 12 is realised in a way known to persons skilled in the art and may be arbitrarily formed, for example, by a snap-on lock, a spring flap clamping device, a clip lock, etc. In the illustrated case the fuel cell stack 24 is arranged in the housing part 14 so that it contacts a lower housing wall of the housing part 14 with a bottom surface and a housing side wall of the housing part 14 with a side surface. The stacking direction of the fuel cell stack 24 corresponds to the vertical direction of FIG. 2. On an upper housing wall of the housing part 14 opposing the lower housing wall three cylindrical orifices 30 (of which only one is shown in FIG. 2) via which the clamping means 28 can apply a corresponding restraint to the fuel cell stack 24 as discussed in detail below are provided above the fuel cell stack 24. The clamping means 28 respectively comprise a ceramic cylinder 26 inserted into the corresponding orifice 30, said ceramic cylinder 26 being movable within the orifice 30 due to a slight clearance. On the one hand the ceramic cylinder 26 contacts the fuel cell stack 24 and is aligned in the stacking direction of the fuel cell stack 24 by the orifice 30. On the other hand the ceramic cylinder 26 contacts a pressure plate 22 of the clamping means 28. The pressure plate 22 is, on the side of the housing, attached to the housing part 14 via at least one screw connection comprising a resilient element 20. In particular the pressure plate 22 is movably guided by the screw connection while it is simultaneously biased towards the corresponding ceramic cylinders 26 by the resilient element 20 in the form of a spring provided on the screw connection. The bias may, for example, be achieved by a correspondingly designed spring disposed between a screw head and the pressure plate 22. With the restraint applied to the corresponding ceramic cylinders 26 ultimately the restraint of the corresponding fuel cell stack 24 is effected. Above that the restraint can be exactly metered or adjusted by tightening or loosening the screw connection. In addition other components 16 of a fuel cell system which are, in the present case, formed as conduits 16 are at least partially accommodated in the coupled housing parts 14, 12. Said conduits 16 may, for example, belong to a reformer or afterburner of the fuel cell system. For accommodating the conduits 16 the housing parts 14, 12 are respectively provided with recesses adjusted to the conduit diameter of the conduits 16 so that the conduits 16 may extend through the housing 10 adjacent to the fuel cell stack 24.

If a plurality of fuel cell stacks 24 is accommodated in the housing parts 14, 12 a plurality of clamping means 28 for respectively restraining the corresponding fuel cell stack are provided. Likewise it is feasible that a plurality of fuel cell stacks 24 are restrained via ceramic cylinders 26 biased towards the fuel cell stacks 24 only by one correspondingly dimensioned, i.e. larger, pressure plate 22.

The features of the invention described in the description, in the drawings as well in the claims may be important for the realisation of the invention individually as well as in combinations.

### LIST OF REFERENCE NUMERALS

10 housing
12 housing part
14 housing part
16 components of the fuel cell system
18 lock of the housing parts
20 resilient element
22 pressure element
24 fuel cell stack
26 clamping body
28 clamping means
30 housing orifice

1. A housing for accommodating at least one fuel cell stack comprising a housing part formed so that it is capable of at least partly accommodating the fuel cell stack, wherein clamping means are provided by which the fuel cell stack is restrainable via at least one orifice of the housing part.

2. The housing of claim 1, wherein the clamping means comprise a clamping body inserted into the orifice for restraining the fuel cell stack.

3. The housing of claim 2, wherein the clamping body is clampable against the fuel cell stack by a force of at least one resilient element.

4. The housing of claim 3, wherein the force of the at least one resilient element attached to the outer side of the housing portion is applicable to the clamping body via a pressure element.

5. The housing of claim 2, wherein the clamping body is a ceramic cylinder.

6. The housing of claim 3, wherein the resilient element comprises at least one spring.

7. The housing of claim 4, wherein the pressure element is a pressure plate or a clamping frame.

8. The housing of claim 7, wherein a plurality of clamping bodies are clampable against the fuel cell stack via the pressure plate.

9. The housing of claim 1, wherein the housing portion is formed of a high-temperature-resistant insulation material.

10. The housing of claim 1, wherein the housing portion is surrounded by a metal shell.

11. The housing of claim 1, wherein the fuel cell stack is restrainable versus the housing portion in its stacking direction.

12. A system comprising a housing of claim 1 and at least one fuel cell stack accommodated therein.
